(19) United States
(12) Patent Application Publication
(10) Pub. No.: US 2026/0302452 A1
(43) Pub. Date: Oct. 1, 2026

(54) CASE FOR SECONDARY BATTERY, SECONDARY BATTERY, AND METHOD OF MANUFACTURING THE SECONDARY BATTERY

(71) Applicant: SAMSUNG SDI CO., LTD., Yongin-si (KR)

(72) Inventors: Hyojin LIM, Yongin-si (KR); Cheonsoo KIM, Yongin-si (KR)

(21) Appl. No.: 19/577,602

(22) Filed: Mar. 25, 2026

(30) Foreign Application Priority Data
Mar. 28, 2025 (KR) 10-2025-0040219

(51) Int. Cl. H01M 50/176; H01M 10/04; H01M 50/103; H01M 50/119; H01M 50/15; H01M 50/169; H01M 50/545; H01M 50/586; H01M 50/627

(52) U.S. Cl. CPC H01M 50/176; H01M 10/049; H01M 50/103; H01M 50/119; H01M 50/15; H01M 50/169; H01M 50/545; H01M 50/586; H01M 50/627

(57) ABSTRACT

A case for a secondary battery includes a lower case that includes a lower receiving space for accommodating a first portion of an electrode assembly and a lower opening and an upper case that includes an upper receiving space for accommodating a second portion of the electrode assembly and an upper opening. A connection part integrally connects a portion of the lower case and a portion of the upper case. The lower case and the upper case are foldable about the connection part such that the lower opening and the upper opening face each other. A through-hole is formed in a side surface of the lower case adjacent to the connection part, with the through-hole being configured for an electrode terminal that is connected to the electrode assembly.

### CROSS-REFERENCE TO RELATED APPLICATION

The present application claims priority to and the benefit of Korean Application No. 10-2025-0040219, filed on Mar. 28, 2025, in the Korean Intellectual Property Office, the entire disclosure of which is incorporated by reference herein.

### BACKGROUND

### Field

The present disclosure relates to a case for a secondary battery, a secondary battery, and a method of manufacturing the secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Attempts have been made to improve the structure of secondary battery cases to enhance the performance and make the secondary batteries safer. For example, designs that maximize the space efficiency of the case of a secondary battery to thereby maximize energy density have been proposed. Furthermore, in designing the case of a secondary battery, the risk of a short circuit may be reduced, and rigidity against an external impact may be secured, thereby making the secondary battery safer.

The above information disclosed in this Background section is for enhancement of understanding of the background of the present disclosure, and therefore, it may contain information that does not constitute related (or prior) art.

### SUMMARY

The present disclosure provides a case for a secondary battery, a secondary battery, and a method of manufacturing a secondary battery to solve the problems as described above.

These and other aspects and features of the present disclosure will be described in or will be apparent from the following description of embodiments of the present disclosure.

In some embodiments, a case for a secondary battery may include a lower case including a lower receiving space configured to accommodate a first portion of an electrode assembly and a lower opening, an upper case including an upper receiving space configured to accommodate a second portion of the electrode assembly and an upper opening, and a connection part integrally connecting a portion of the lower case and a portion of the upper case, wherein the lower case and the upper case are foldable about the connection part and are connected such that the lower opening and the upper opening face each other, and a through-hole is formed in a side surface of the lower case adjacent to the connection part, with the through-hole being configured for an electrode terminal that is connected to the electrode assembly.

The lower case may include a bottom part, and a lower sidewall part extending from the bottom part toward the lower opening, and the upper case may include a top part and an upper sidewall part extending from the top part toward the upper opening.

A height of the lower sidewall part of the lower case may be greater than a height of the upper sidewall part of the upper case.

The through-hole may be formed in a region of the lower sidewall part such that an electrical short circuit between the upper case and the electrode terminal cannot occur.

The upper case may further include an upper flange part extending outward from an end the upper sidewall part excluding a portion of the upper sidewall part corresponding to the connection part, and the lower case further may include a lower flange part extending outward from an end of the lower sidewall part excluding a portion of the lower sidewall part corresponding to the connection part.

The upper flange part and the lower flange part may be connected by welding.

An electrolyte injection port may be further formed in the side surface of the lower case adjacent to the connection part.

At least one of the upper case and the lower case may be formed from Stainless Use Steel.

A secondary battery may include an electrode assembly including a first electrode, a second electrode, and a separator interposed between the first electrode and the second electrode, a lower case including a lower receiving space accommodating a first portion of the electrode assembly and a lower opening, an upper case including an upper receiving space accommodating a second portion of the electrode assembly and an upper opening, and a connection part integrally connecting a portion of the lower case and a portion of the upper case, wherein the lower case and the upper case are folded about the connection part and are connected such that the lower opening and the upper opening are disposed to face each other, and a through-hole is formed in a side surface of the lower case adjacent to the connection part, with an electrode terminal electrically connected to the electrode assembly being disposed in the through-hole.

The lower case may include a bottom part, and a lower sidewall part extending from the bottom part toward the lower opening, and the upper case may include a top part and an upper sidewall part extending from the top part toward the upper opening.

A height of the lower sidewall part of the lower case may be greater than a height of the upper sidewall part of the upper case.

The through-hole may be formed in a region of the lower sidewall part such that an electrical short circuit between the upper case and the electrode terminal cannot occur.

The upper case may further include an upper flange part extending outward from an end of the upper sidewall part, excluding a portion of the upper sidewall part corresponding to the connection part, and the lower case may further include a lower flange part extending outward from an end the lower sidewall part excluding a portion of the lower sidewall part corresponding to the connection part.

The upper flange part and the lower flange part may be connected by welding.

At least one of the upper case and the lower case may have the secondary battery electrically connected to the second electrode.

An electrolyte injection port may be further formed on the side surface of the lower case adjacent to the connection part.

In some embodiments, a method of manufacturing a secondary battery, may include preparing an electrode assembly may include a first electrode, a second electrode, and a separator interposed between the first electrode and the second electrode, preparing a lower case including a lower receiving space for accommodating a first portion of the electrode assembly and a lower opening, and an upper case including an upper receiving space for accommodating a second portion of the electrode assembly and an upper opening, wherein a portion of the upper case and a portion of the lower case are integrally connected by a connection part, inserting the electrode assembly into the lower receiving space of the lower case, and connecting the upper case and the lower case by folding the lower case and the upper case about the connection part such that the lower opening and the upper opening face each other.

The lower case may include a bottom part and a lower sidewall part extending from the bottom part toward the lower opening, and the upper case may include a top part and an upper sidewall part extending from the top part toward the upper opening.

A height of the lower sidewall part of the lower case may be greater than a height of the upper sidewall part of the upper case.

Preparing the lower case and the upper case may include forming a through-hole in a region of the lower sidewall part, the method may further include disposing the electrode terminal in the through-hole, and electrically connecting the electrode terminal and the first electrode, and the region of the lower sidewall part may be positioned such that an electrical short circuit between the upper case and the electrode terminal cannot occur.

According to embodiments of the present disclosure, each of the lower case and the upper case of the secondary battery provides receiving space that accommodates a portion of the electrode assembly such that the lower case and the upper case respectively support the upper and lower portions of the electrode assembly, thereby making it possible to optimize the thickness of the entire case.

According to embodiments of the present disclosure, thicknesses of each of the lower case and the upper case of the secondary battery are reduced, which make the secondary battery lightweight and thin.

According to embodiments of the present disclosure, the structural strength of the secondary battery is maintained, and the secondary battery may be made safer by protecting the electrode assembly from external impacts and vibrations.

According to embodiments of the present disclosure, the energy density (Energy Density, ED) of the secondary battery may be improved.

According to embodiments of the present disclosure, the sizes of the lower receiving space and the upper receiving space formed in the case of the secondary battery are determined by considering the arrangement of other components of the secondary battery. By doing so, it can be ensured that the upper case of conductive material and the electrode terminal do not contact each other, thereby preventing the risk of different electrodes being short-circuited.

According to embodiments of the present disclosure, a short circuit between the electrode terminal disposition region or the electrolyte injection port and the flange part in the case of the secondary battery may be prevented. That is, unnecessary electrical contact between the flange part of the case and the electrode terminal during the manufacturing process of the secondary battery may be minimized, and electrolyte injection may be safe and easy. Further, by preventing unnecessary short circuits and ensuring the stability of the electrolyte injection process, the structural safety and convenience of the secondary battery may be improved.

According to embodiments of the present disclosure, a lower flange part and an upper flange part are formed at ends of portions of the lower sidewall part and the upper sidewall part of the case of the secondary battery, respectively, and the remaining portions of each of the lower sidewall part and the upper sidewall part are integrally formed through a connection part. Thus, the process time required for cutting and welding the lower case and the upper case during the manufacturing of the secondary battery may be reduced.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a case for a secondary battery according to an embodiment of the present disclosure.

FIG. 2 is a perspective view of the case for the secondary battery depicted in FIG. 1 with an electrode terminal disposed therein, viewed from a direction A.

FIG. 3 is a side view of the case for the secondary battery depicted in FIG. 1 with an electrode terminal disposed therein, viewed from the direction A.

FIG. 4 is a cross-sectional view of the case for the secondary battery depicted in FIG. 1.

FIG. 5 is a cross-sectional view of the case for the secondary battery depicted in FIG. 1 with an electrode terminal disposed therein.

FIG. 6 is an exploded perspective view of a secondary battery according to an embodiment of the present disclosure.

FIG. 7 is a flowchart for a method of manufacturing a secondary battery according to an embodiment of the present disclosure.

FIGS. 8 to 14 illustrate a method of manufacturing a secondary battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of” A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the scope of the disclosure.

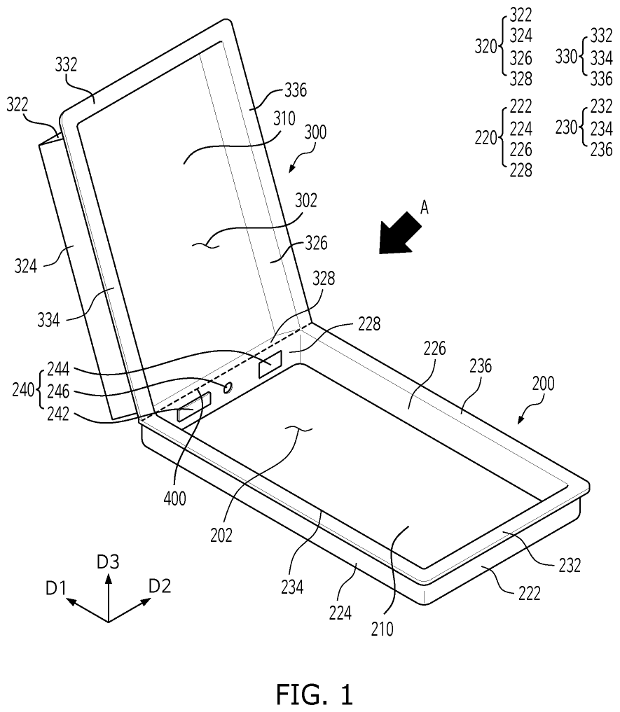

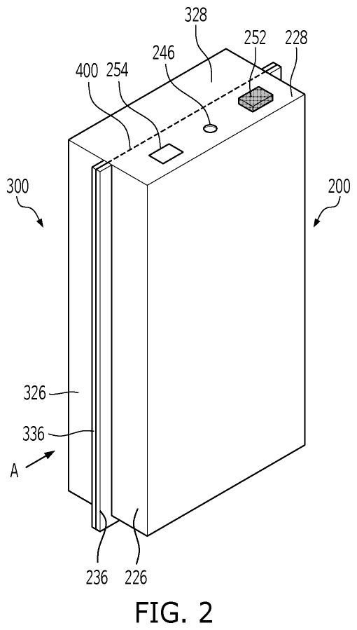

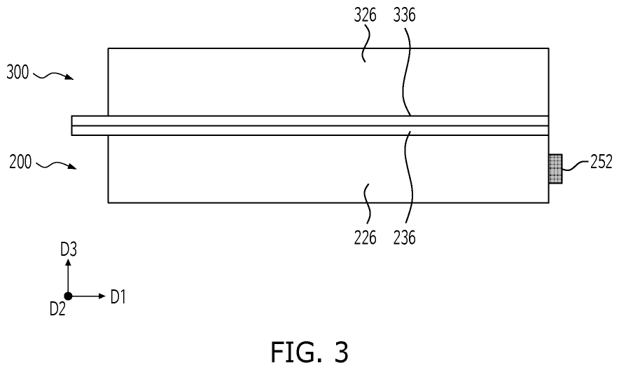

FIG. 1 is an exploded perspective view of a case for a secondary battery according to an embodiment of the present disclosure. FIG. 2 is an exemplary perspective view of the case for the secondary battery depicted in FIG. 1 with an electrode terminal disposed therein, as viewed from a direction A. FIG. 3 is a side view of the case for the secondary battery depicted in FIG. 1 with an electrode terminal disposed therein, as viewed from the direction A.

Referring to FIG. 1, a case for a secondary battery according to an embodiment of the present disclosure may include a lower case 200 including a lower receiving space 202 for accommodating at least a portion of an electrode assembly and a lower opening where a side of the lower receiving space 202 is open. The case may also include an upper case 300 including an upper receiving space 302 for accommodating at least a portion of the electrode assembly and an upper opening where the upper receiving space 302 is open. A connection part 400 may integrally connect a portion of the lower opening and a portion of the upper opening. Here, at least one of the lower case 200 and the upper case 300 may be formed from a material including Stainless Use Steel (SUS).

In an embodiment, a lower case 200 may include a lower receiving space 202 and a lower opening. The lower case 200 may include a bottom part 210 and a lower sidewall part 220 extending from the bottom part 210 toward the lower opening. The lower receiving space 202 may be defined by the bottom part 210 and the lower sidewall part 220. The lower opening may refer to an open upper end of the lower case 200 and may be defined by an end of the lower sidewall part 220. The lower receiving space 202 may accommodate at least a portion of the electrode assembly (for example, a lower portion of the electrode assembly) inserted through the lower opening.

The lower case 200 may include a bottom part 210. The bottom part 210 may be located at a lower end of the lower case. Referring to FIG. 1, the bottom part 210 may be configured in the shape of a rectangle or a rectangle with rounded corners. However, the shape and structure of the bottom part 210 are not limited thereto. For example, the bottom part 210 may be configured in various other shapes such that the electrode assembly can be stably seated in the lower receiving space 202.

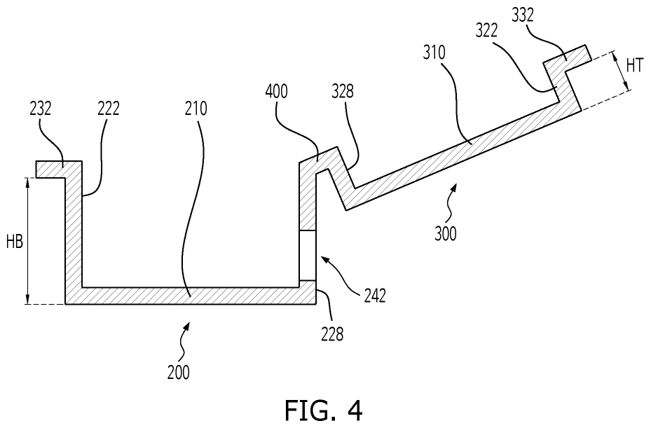

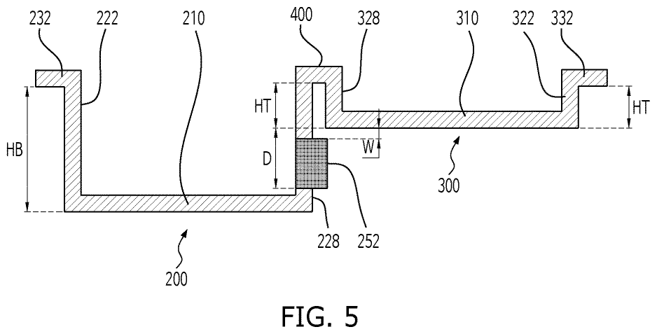

The lower case 200 may include a lower sidewall part 220. The lower sidewall part 220 may be configured to extend from the bottom part 210 toward the lower opening. Referring to FIG. 1, the lower sidewall part 220 may include a first lower sidewall part 222, a second lower sidewall part 224, a third lower sidewall part 226, and a fourth lower sidewall part 228, with these parts extending vertically to a predetermined height from the outer peripheries of the bottom part 210. However, the shape and structure of the lower sidewall part 220 are not limited thereto. The lower sidewall part 220 may be configured in various shapes such that the electrode assembly accommodated in the lower receiving space 202 is seated in a predetermined region and protected from external impacts or vibrations. For example, the lower sidewall part 220 may be configured to be inclined at a predetermined angle from the outer periphery of the bottom part 210 and extend toward the lower opening. The lower sidewall part 220 may be coupled with the bottom part 210 to define the lower receiving space 202 and the lower opening where the lower receiving space 202 is open. A detailed description of the structure between the lower sidewall part 220 and an upper sidewall part 320 will be described below with reference to FIGS. 4 and 5.

The lower case 200 may include a lower flange part 230. The lower flange part 230 may extend from an end of the lower sidewall part 220 towards outside of the lower case 200. In particular, the lower flange part 230 may extend to outside of the lower case 200 from ends of the first lower sidewall part 222, the second lower sidewall part 224, and the third lower sidewall part 226), but not a portion of the fourth lower sidewall part 228, which corresponds to a connection part 400 that integrally connects a portion of the lower case 200 and a portion of an upper case 300. Referring to FIG. 1, the lower flange part 230 may include a first lower flange part 232 extending from an end of the first lower sidewall part 222 in an outward direction (−D1 direction) of the lower case 200, a second lower flange part 234 extending from an end of the second lower sidewall part 224 in an outward direction (−D2 direction) of the lower case 200, and a third lower flange part 236 extending from an end of the third lower sidewall part 226 in an outward direction (D2 direction) of the lower case 200. The lower flange part 230 may provide an area for connection to the upper case 300.

The lower case 200 may include one or more through-holes 240. The through-holes 240 may include a first through-hole 242 in which a first electrode terminal connected to a first electrode is disposed or inserted, and/or a second through-hole 244 in which a second electrode terminal connected to a second electrode is disposed or inserted. In addition, the through-holes 240 may further include a third through-hole 246 that may function as an electrolyte injection port through which an electrolyte is injected into the lower case 200.

The through-holes 240 may be formed on a surface of the lower sidewall part 220 of the lower case 200. For example, the first through-hole 242 and the second through-hole 244 may be formed on a side surface of the lower case 200 adjacent to the connection part 400. The third through-hole 246, as an electrolyte injection port, may be formed on a side surface of the lower case 200 adjacent to the connection part 400. Referring to FIG. 1, the third through-hole 246 functioning as the electrolyte injection port may be formed in an area between the first through-hole 242 and the second through-hole 244 and/or at the center of the side surface of the lower case 200 adjacent to the connection part 400.

Referring to FIGS. 2 and 3, a first electrode terminal 252 may protrude outward from an outer surface of the lower case 200. The first electrode terminal 252 may be inserted into the first through-hole 242 formed in a fourth lower sidewall part 228 and protrude outward from an outer surface of the fourth lower sidewall part 228. The direction in which the first electrode terminal 252 protrudes may be a length direction D1 of the lower case 200. The first electrode terminal 252 may be in the form of a plate. However, the shape of the first electrode terminal 252 is not limited, and the first electrode terminal 252 may be formed in various shapes or structures (e.g., a rivet, etc.) so as to be fixed and protrude outside the lower case 200 by being inserted into the first through-hole 242 and to be physically separated from the case functioning as a second electrode.

Referring to FIGS. 2 and 3, a second electrode terminal 254 may extend in the same plane as an outer surface of the lower case 200. For example, the second electrode terminal 254 may be formed so as not to protrude beyond the outer surface of the fourth lower sidewall part 228 of the lower case 200. A thickness of the fourth lower sidewall part 228 and a thickness of the second electrode terminal 254 may be substantially the same, or the thickness of the second electrode terminal 254 may be less than the thickness of the fourth lower sidewall part 228. As such, the second electrode terminal 254 may not protrude outside of the fourth lower sidewall part 228.

The through-hole(s) 240 may be formed on a surface of a lower sidewall part (e.g., a fourth sidewall part 228) corresponding to the connection part 400. This configuration provides a structure in which a lower flange part is not formed on the lower sidewall part where the through-hole(s) 240 is formed, thereby reducing the risk of a short circuit between an electrode terminal and the lower flange part and increasing the efficiency of the process during electrolyte injection. A detailed description of the position where the through-hole(s) 240 is formed in the configuration where the lower case 200 and the upper case 300 are connected will be described below with reference to FIGS. 4 and 5.

The upper case 300 may include an upper receiving space 302 and an upper opening. The upper case 300 may include a top part 310 and an upper sidewall part 320 extending from the top part 310 toward the upper opening. The upper receiving space 302 may be defined by the top part 310 and the upper sidewall part 320. The upper opening is an open end of the upper case 300 and may be defined by an end of the upper sidewall part 320. The upper receiving space 302 may accommodate at least a portion of the electrode assembly (for example, an upper portion of the electrode assembly) inserted through the upper opening.

The top part 310 may be located at an upper end of the upper case. Referring to FIG. 1, the top part 310 may be configured in a rectangular shape or a rectangular shape with rounded corners. However, the shape and structure of the top part 310 are not limited thereto. For example, the top part 310 may be configured in various other shapes so that the electrode assembly is stably seated in the upper receiving space 302.

The upper case 300 may include an upper sidewall part 320. The upper sidewall part 320 may be configured to extend from the top part 310 toward the upper opening. Referring to FIG. 1, the upper sidewall part 320 may include a first upper sidewall part 322, a second upper sidewall part 324, a third upper sidewall part 326, and a fourth upper sidewall part 328, which are extend by a predetermined length from the outer periphery of the top part 310. However, the shape and structure of the upper sidewall part 320 are not limited thereto. The upper sidewall part 320 may be configured in various other shapes so that the electrode assembly accommodated in the upper receiving space 302 is seated in a predetermined region and protected from external impacts or vibrations. For example, the upper sidewall part 320 may be configured to be inclined at a predetermined angle from the outer periphery of the top part 310 and extend toward the upper opening. The upper sidewall part 320 may be coupled with the top part 310 to define the upper receiving space 302 and the upper opening where a side of the upper receiving space 302 is open.

Referring again to FIG. 1, the upper case 300 may include an upper flange part 330. The upper flange part 330 may extend from an end of the upper sidewall part 320 to outside of the upper case 300. In particular, the upper flange part 330 may extend to outside of the upper case 300 from ends of the first upper sidewall part 322, the second upper sidewall part 324, and the third upper sidewall part 326), but not the fourth upper sidewall part 328, which corresponds to the connection part 400 that integrally connects a portion of the lower case 200 and a portion of the upper case 300. Referring to FIG. 1, the upper flange part 330 may include a first upper flange part 332 extending from an end of the first upper sidewall part 322 in an outward direction (−D1 direction) of the upper case 300, a second upper flange part 334 extending from an end of the second upper sidewall part 324 in an outward direction (−D2 direction) of the upper case 300, and a third upper flange part 338 extending from an end of the third upper sidewall part 326 in an outward direction (D2 direction) of the upper case 300. The upper flange part 330 may provide an area for connection to the lower case 200.

Referring to FIGS. 2 and 3 the lower flange part 230 and the upper flange part 330 may be connected by welding. However, the method of connecting the lower flange part 230 and the upper flange part 330 is not limited in this regard and may be various connection methods such as adhesion, brazing, soldering, and thermal fusion.

The connection part 400 may integrally connect a portion of the lower sidewall part 220 and a portion of the upper sidewall part 320. Further, the lower case 200 and the upper case 300 may be folded about the connection part 400. Referring to FIG. 1, the connection part 400 may integrally connect an end of the fourth lower sidewall part 228 and an end of a fourth upper sidewall part 328. In addition, the connection part 400 integrally connect an end of a second lower flange part 234 and an end of a second upper flange part 334 and/or integrally connect an end of a third lower flange part 236 and an end of a third upper flange part 336. For example, among the end of the second lower flange part 234 and the end of the second upper flange part 334, the portions adjacent to the fourth lower sidewall part 228 and the fourth upper sidewall part 328 may be integrally connected. However, the structure of the connection part 400 and the flange parts is not limited to this example. In other embodiments, an end of the fourth lower sidewall part 228 and an end of the fourth upper sidewall part 328 are integrally connected by the connection part 400, but an end of the second lower flange part 234 and an end of the second upper flange part 334 do not contact each other, and/or an end of the third lower flange part 236 and an end of the third upper flange part 336 do not contact each other.

FIG. 4 is a cross-sectional view of the case for the secondary battery depicted in FIG. 1. FIG. 5 is a cross-sectional view of the case for the secondary battery depicted in FIG. 1 with an electrode terminal disposed therein. Referring to FIGS. 4 and 5, the case for a secondary battery may include a lower case 200 including a lower receiving space 202 and a lower opening, an upper case 300 including an upper receiving space 302 and an upper opening, and a connection part 400 integrally connecting a portion of the lower case 200 and a portion of the upper case 300. The lower case 200 may include a bottom part 210, a lower sidewall part 222, 228 extending from the bottom part 210 to the lower opening, and a lower flange part 232 extending from an end of the lower sidewall part to outside of the lower case 200. The upper case 300 may include a top part 310, an upper sidewall part 322, 328) extending from the top part 310 to the upper opening, and an upper flange part 332 extending from an end of the upper sidewall part to outside of the upper case 300.

A height HB of the lower sidewall part may be greater than a height HT of the upper sidewall part. Here, as shown in FIG. 4, the height HB of the lower sidewall part is the distance from an outer surface of the bottom part 210 to an end of the lower sidewall part where the lower opening is formed and to the lower flange part. The height HT of the upper sidewall part is the distance from an outer surface of the top part 310 to an end of the upper sidewall part where the upper opening is formed and to the upper flange part. With this configuration, a depth and a volume of the lower receiving space 202 of the lower case 200 may be greater than a depth and a volume of the upper receiving space 302 of the upper case 300.

A through-hole may be formed in a side surface of the lower case. As described above, the through-hole may include first and second through-holes in which electrode terminals are disposed and a third through-hole that functions as an electrolyte injection port into which an electrolyte is injected. In the example depicted in FIG. 4, a first through-hole 242 is formed in a partial region of a fourth lower sidewall part 228.

An electrode terminal electrically connected to an electrode assembly may be disposed in the through-hole. For example, a first electrode terminal 252 may be inserted and disposed in the first through-hole 242, with the first electrode terminal 252 being electrically connected to a first electrode of the electrode assembly.

The through-hole may be formed in the side surface of the lower case 200 such that an electrode terminal is disposed in a region of the side surface that is adjacent to the connection part 400. Here, the region may include at least a partial region of a side surface of the lower case 200 adjacent to the connection part 400 or the surface the fourth lower sidewall part 228. The first through-hole 242 may be formed in the side surface of the fourth lower sidewall part 228 such that a part of the upper case 300 does not contact the first electrode terminal 252 when the upper case 300 is bent about the connection part 400. For example, as depicted in FIG. 5, the first through-hole 242 may be formed in a region that is in a predetermined length D from the boundary spaced by a height HT of the upper case 300 on the fourth lower sidewall part 228 of the lower case 200 where the connection part 400 is located. The first electrode terminal 252 may be inserted and disposed in the first through-hole 242. With this configuration, a clearance W may be formed so that the upper case 300 does not contact the first electrode terminal protruding to outside of the lower case when the upper case 300 is bent about the connection part 400. This configuration can prevent the risk of a short circuit between different electrodes by preventing the conductive upper case 300 and the first electrode terminal 252 from contacting each other.

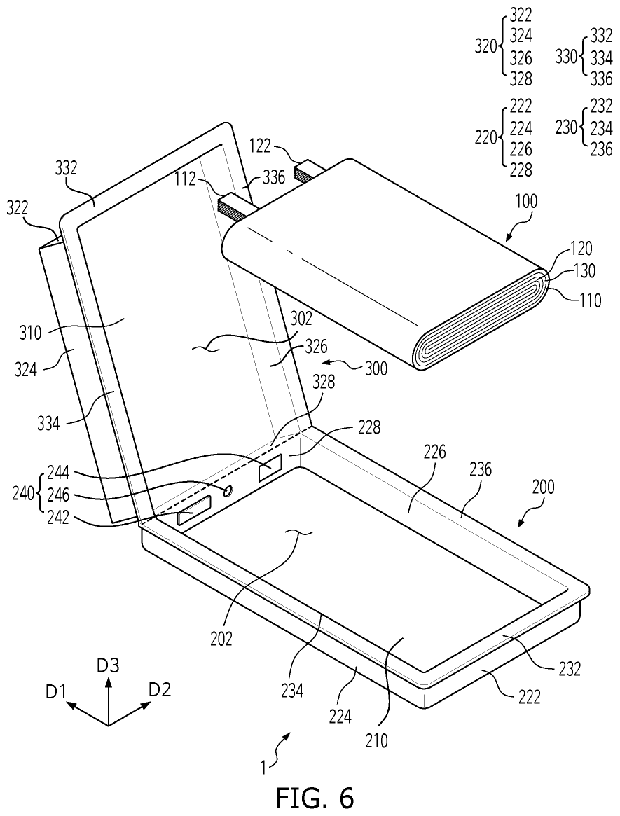

FIG. 6 is an exploded perspective view of a secondary battery according to an embodiment of the present disclosure.

A secondary battery 1 may include an electrode assembly 100, a lower case 200 including a lower receiving space 202 that accommodates at least a portion of the electrode assembly 100 and a lower opening where the lower receiving space is open, an upper case 300 including an upper receiving space 302 that accommodates at least a portion of the electrode assembly 100 and an upper opening where the upper receiving space is open, and a connection part 400 that integrally connects a portion of the lower case 200 and a portion of the upper case 300. The lower case 200 may include a bottom part 210, a lower sidewall part 220, and a lower flange part 230. Through-holes 240 may be formed in a portion of the lower sidewall part 220. A first electrode terminal is disposed in a first through-hole 242, a second electrode terminal is disposed in a second through-hole 244, and an electrolyte may be injected through a third through-hole 246. The upper case 300 may include a top part 310, an upper sidewall part 320, and an upper flange part 330.

An electrode assembly 100 may include a first electrode 110, a second electrode 120, and a separator 130 interposed between the first electrode 110 and the second electrode 120. The first electrode 110 may be a positive electrode, and the second electrode 120 may be a negative electrode. However, the present disclosure is not limited thereto, and the polarities of the electrodes may be reversed. Here, each of the first electrode 110 and the second electrode 120 may include an electrode plate formed in a thin plate or film shape. In the embodiment depicted in FIG. 6, the electrode assembly 100 may be formed by winding a stack of a first electrode plate, a separator 130, and a second electrode plate. A winding axis of the electrode assembly 100 may be in the direction D1 of the lower case 200. However, the electrode assembly 100 is not limited to such a configuration. For example, the electrode assembly 100 may be a stack-type electrode assembly formed by stacking a stack of the first electrode plate, the separator 130, and the second electrode plate.

The first electrode 110 may be a positive electrode. The first electrode 110 or a first electrode plate may include a first current collector formed of a metal foil such as aluminum or an aluminum alloy, and a first active material applied to a portion of the first current collector and including a transition metal oxide or the like. In addition, the first electrode 110 may include a first uncoated portion and a first electrode tab 112. The first uncoated portion may be a region of the first current collector where the first active material is not provided. The first electrode tab 112 may be formed integrally with the first uncoated portion or may be formed on a second uncoated portion by welding or the like. The first electrode tab 112 may be connected to the first electrode plate to provide a path for current flow between a first electrode terminal disposed in the first through-hole 242 and the first electrode. The first electrode tab 112 may be formed by cutting a side of the first electrode plate or by joining a separate tab to the first electrode plate by a method such as welding.

The second electrode 120 may be a negative electrode. The second electrode 120 or a second electrode plate may include a second current collector formed of a metal foil such as copper, a copper alloy, nickel, or a nickel alloy, and a second active material applied to a portion of the second current collector, with the second active material including graphite or carbon. The second electrode 120 may also include a second uncoated portion and a second electrode tab 122. The second uncoated portion may correspond to a region of the second current collector where the second active material is not provided. The second electrode tab 122 may be formed integrally with the second uncoated portion or may be formed on the second uncoated portion through welding or the like. The second electrode tab 122 may be connected to the second electrode plate to provide a path for current flow between a second electrode terminal disposed in the second through-hole 244 and the second electrode. The second electrode tab 122 may be formed by cutting one side of the second electrode plate or by joining a separate tab to the second electrode plate by a method such as welding.

Each of the lower case 200 and the upper case 300 may form an external appearance of the secondary battery 1. The lower case 200 and/or the upper case 300 may be made of a material that has a predetermined strength and can exhibit electrolyte resistance. Further, the lower case 200 and/or the upper case 300 may be formed of a conductive material such as aluminum, nickel-plated steel, Stainless Use Steel, or an alloy thereof. Here, the stainless steel may include either SUS304 or SUS316, but the present disclosure is not limited thereto.

Each of the lower case 200 and the upper case 300 may provide a receiving space for accommodating the electrode assembly 100. In particular, the lower case 200 may include a lower receiving space 202 for accommodating a portion of the electrode assembly 100. The upper case 300 may include an upper receiving space 302 for accommodating the remaining portion of the electrode assembly 100.

In this configuration, the lower case 200 and the upper case 300 each support a part of the electrode assembly 100, thereby making it possible to optimize the thickness of the entire case. To accommodate an electrode assembly 100, if each of the lower case 200 and the upper case 300 provides a lower receiving space 202 and an upper receiving space 302, the thickness of each case 200, 300 is reduced, and the weight and thickness of the secondary battery 1 may be ensured to be reduced. In addition, the structural strength of the secondary battery 1 is maintained, and the battery is made safer because the electrode assembly is protected from external impacts and vibrations. Furthermore, the energy efficiency (Energy Density, ED) of the secondary battery 1 may be improved.

The sizes of the lower receiving space 202 and the upper receiving space 302 provided by each of the lower case 200 and the upper case 300 may be the same or different. Here, the sizes of the lower receiving space 202 and the upper receiving space 302 may be determined in consideration of other aspects of the secondary battery 1. For example, an electrode terminal may be disposed on one side of the lower case 200, or a through-hole 240 functioning as an electrolyte injection port may be formed. The first electrode 110 of the electrode assembly 100 may be connected to a first electrode terminal inserted and disposed in a first through-hole 242. The second electrode 120 may be connected to a second electrode terminal disposed in a second through-hole 244. In such a configuration, the lower case 200 and the upper case 300 are electrically connected to the second electrode terminal and may function as the second electrode. If the upper case 300, which serves as the second electrode, and the first electrode terminal, which serves as the first electrode, physically contact each other, there is a risk of an electrical short circuit. Accordingly, when the secondary battery 1 is opened and closed, each of the lower case 200 and the upper case 300 may be configured such that a height (or depth in a D3 direction) of the lower case 200 is greater than a height (or depth) of the upper case 300. Thus, there is no risk of an electrical short circuit between the upper case 300 and the first electrode terminal. In addition, the lower receiving space 202 may be larger than the upper receiving space 302.

A portion of the lower case 200 and a portion of the upper case 300 may be integrally formed through a connection part 400. The lower case 200 and the upper case 300 may be folded about the connection part 400. As such, the lower case 200 and the upper case 300 may be connected with the lower opening and the upper opening facing each other.

The secondary battery 1 may include a lower flange part 230 and an upper flange part 330. Here, the lower flange part 230 and the upper flange part 330 may be formed in consideration of other aspects of the secondary battery 1. For example, the lower flange part 230 may include a first lower flange part 232 extending from an end of a first lower sidewall part 222 in an outward direction (−D1 direction) of the lower case 200, a second lower flange part 234 extending from an end of a second lower sidewall part 224 in an outward direction (−D2 direction) of the lower case 200, and a third lower flange part 236 extending from an end of a third lower sidewall part 226 in an outward direction (D2 direction) of the lower case 200. The upper flange part 330 may include a first upper flange part 332 extending from an end of a first upper sidewall part 322 in an outward direction (−D1 direction) of the upper case 300, a second upper flange part 334 extending from an end of a second upper sidewall part 324 in an outward direction (−D2 direction) of the upper case 300, and a third upper flange part 336 extending from an end of a third upper sidewall part 326 in an outward direction (D2 direction) of the upper case 300. However, a lower flange part and an upper flange part may not be formed at the ends of a fourth lower sidewall part 228 and a fourth upper sidewall part 328 corresponding to the connection part 400. An electrode terminal may be disposed or an electrolyte injection port may be formed in either the fourth lower sidewall part 228 or the fourth upper sidewall part 328.

The configuration described above can effectively prevent the possibility of a short circuit between the electrode terminal disposition region or the electrolyte injection port and the flange part. That is, unnecessary electrical contact between the flange part and the electrode terminal that may occur when the secondary battery 1 is opened and closed is minimized, and the injection is convenient and safe. By preventing unnecessary short circuits and making the electrolyte injection process safer, the structural safety and convenience of the secondary battery 1 can be improved.

A lower flange part 230 and an upper flange part 330 are formed at and end of a portion of each of a lower sidewall part 220 and an upper sidewall part 320, respectively, and the remaining portions of the lower sidewall part 220 and the upper sidewall part 320 are integrally formed through a connection part 400, so that the process time required for cutting and welding the lower case 200 and the upper case 300 during the manufacturing of the secondary battery 1 can be reduced.

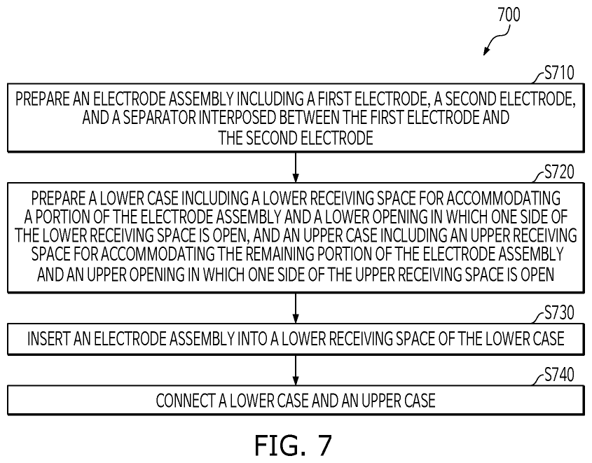

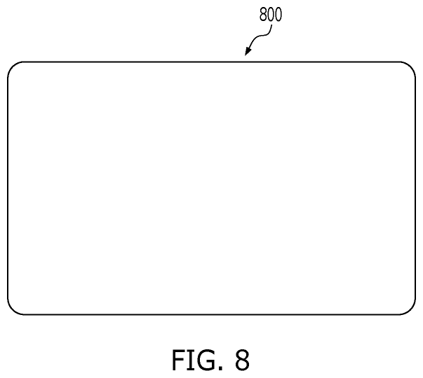

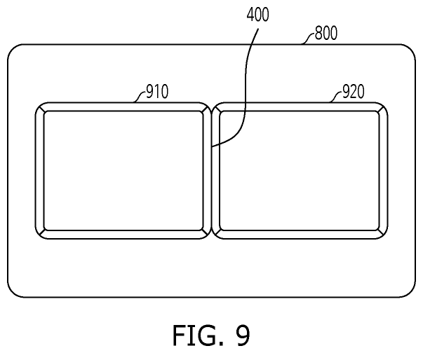

FIG. 7 is a flowchart of a method of manufacturing a secondary battery according to an embodiment of the present disclosure. FIGS. 8 to 14 illustrate a method of manufacturing a secondary battery according to an embodiment of the present disclosure.

A method 700 of manufacturing a secondary battery may begin with a step S710 of preparing an electrode assembly including a first electrode, a second electrode, and a separator interposed between the first electrode and the second electrode.

In a step S720, a lower case including a lower receiving space for accommodating a portion of the electrode assembly and a lower opening, and an upper case including an upper receiving space for accommodating the remaining portion of the electrode assembly and an upper opening, may be prepared.

Referring to FIGS. 7 and 8, in the step S720, a metal plate (e.g., SUS raw material, 800) for forming a case may be prepared. A shape of a lower case and an upper case may be created by forming each of a lower receiving space 920 and an upper receiving space 920 in a metal plate 800. Here, a processing method such as deep drawing may be used. For example, the shapes of the lower case and the upper case described above may be made by processing a SUS raw material by blanking, drawing, and trimming. However, the method of forming each of the lower receiving space 920 and the upper receiving space 920 is not limited in this regard.

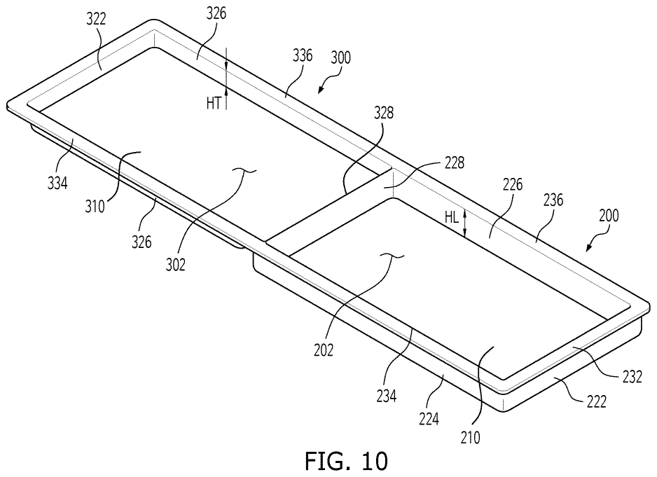

Referring to FIG. 10, a lower case 200 includes a bottom part 210, and lower sidewall parts 222, 224, 226, 228 extending from the bottom part 210 toward a lower opening, and an upper case 300 includes a top part 310 and upper sidewall parts 322, 324, 326, 328 extending from the top part 310 toward an upper opening. A height HL of a lower sidewall part of the lower case 200 may be greater than a height HT of an upper sidewall part of the upper case 300. A portion of the upper case 200 and a portion of the lower case 300 may be integrally connected through a connection part 400.

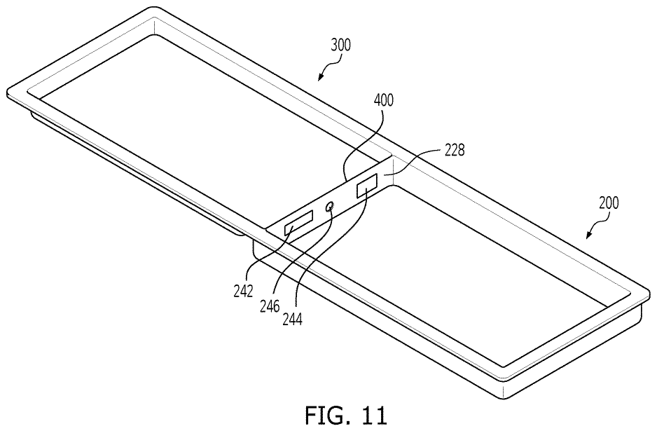

Referring to FIGS. 7 and 11, in the step S720, through-holes 242, 244, 246 are formed in a surface of a portion (e.g., a fourth lower sidewall part 228) of a lower sidewall part of the lower case 200. The through-holes 242, 244, 246 are formed in a predetermined region of the fourth lower sidewall part 228 so that the risk of an electrical short circuit between the upper case 300 and an electrode terminal is prevented and the electrolyte injection is made easy.

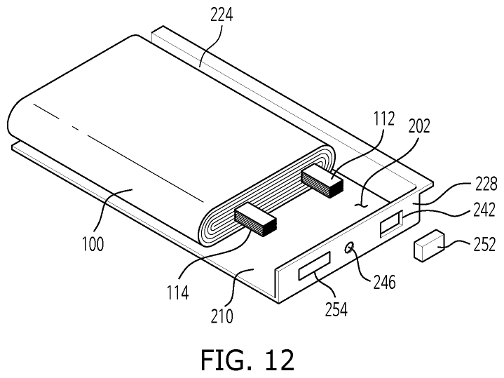

In a step S730, an electrode assembly may be inserted into a lower receiving space of the lower case. Referring to FIG. 12, a first electrode terminal 252 to be connected to a first electrode is inserted and disposed in a first through-hole 242, and a second electrode terminal 254 to be connected to a second electrode is inserted and disposed in a second through-hole 244. An electrode assembly 100 is inserted into a lower receiving space 202 of the lower case 200 such that a first electrode tab 112 is connected to the first electrode terminal 252, and a second electrode tab 122 is connected to the second electrode terminal 254.

In step S740, the lower case and the upper case may be connected where they are folded about a connection part, with a lower opening and an upper opening thereby being made to face each other.

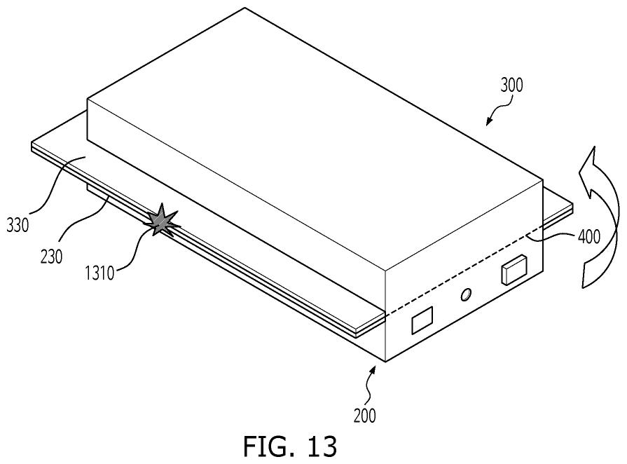

Referring to FIG. 13, a lower case 200 and an upper case 300 may be connected. In particular, the lower case 200 and the upper case 300 may be folded about a connection part 400. A lower flange part 230 and an upper flange part 330 may face each other and be connected by a method such as welding 1310. Through this, the lower case 200 and the upper case 300 may be sealed. Here, welding is not performed on the connection part 400, so that welding foreign matter and/or roughness may not occur. In addition, since the welded portion is reduced, the process time may be shortened.

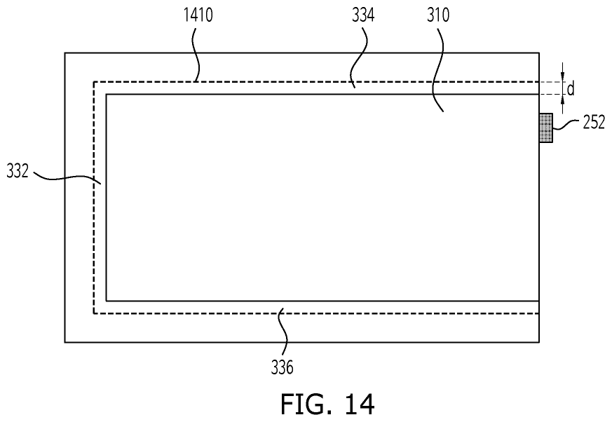

Referring to FIG. 14, a lower flange part and upper flange parts 332, 334, 336 connected by welding may be cut along a cutting line 1410. For example, the cutting process may be performed by laser cutting. The lower flange part and the upper flange parts 332, 334, 336 may be cut along an outer end 1410 spaced by a predetermined distance d from a corner of each of the lower case and the upper case 300. As such, the lower flange part and the upper flange parts 332, 334, 336 may extend a distance d after the cutting.

Because a lower flange part and an upper flange part are not formed on the side surface of the lower case where a first electrode terminal 252 is formed, a separate cutting process is not necessary. Accordingly, it may not be necessary to define a cutting portion to prevent a short circuit between the first electrode terminal 252 and the case. In addition, by omitting the cutting process, the process time can be shortened.

The flowchart of FIG. 7 and the above-described explanations are only examples of the present disclosure, and the scope of the present disclosure is not limited to the flowchart of FIG. 7 and the above-described explanations. For example, any one or more steps among the flowchart and the above-described explanations may be added/changed/deleted. In addition, the order of one or more steps may be changed, and one or more steps may be performed simultaneously.

Although the present disclosure has been described above with respect to embodiments thereof, the present disclosure is not limited thereto. Various modifications and variations can be made thereto by those skilled in the art within the spirit of the present disclosure.

### DESCRIPTION OF REFERENCE SYMBOLS

1: secondary battery
100: electrode assembly
200: lower case
300: upper case
400: connection part

What is claimed is:

1. A case for a secondary battery, the secondary battery comprising:
a lower case comprising a lower receiving space configured to accommodate a first portion of an electrode assembly and a lower opening;
an upper case comprising an upper receiving space configured to accommodate a second portion of the electrode assembly and an upper opening; and
a connection part integrally connecting a portion of the lower case and a portion of the upper case,
wherein the lower case and the upper case are foldable about the connection part and are connected such that the lower opening and the upper opening are face each other, and
wherein a through-hole is formed in a side surface of the lower case adjacent to the connection part, with the through-hole being configured for an electrode terminal that is connected to the electrode assembly.

2. The case for a secondary battery as claimed in claim 1, wherein the lower case comprises a bottom part and a lower sidewall part extending from the bottom part toward the lower opening, and the upper case comprises a top part and an upper sidewall part extending from the top part toward the upper opening.

3. The case for a secondary battery as claimed in claim 2, wherein a height of the lower sidewall part of the lower case is greater than a height of the upper sidewall part of the upper case.

4. The case for a secondary battery as claimed in claim 2, wherein the through-hole is formed in a region the lower sidewall part such that an electrical short circuit between the upper case and the electrode terminal cannot occur.

5. The case for a secondary battery as claimed in claim 2, wherein the upper case further comprises an upper flange part extending outward from an end of the upper sidewall part excluding a portion of the upper sidewall part corresponding to the connection part, and the lower case further comprises a lower flange part extending outward from an end of the lower sidewall part excluding a portion of the lower sidewall part corresponding to the connection part.

6. The case for a secondary battery as claimed in claim 5, wherein the upper flange part and the lower flange part are connected by welding.

7. The case for a secondary battery as claimed in claim 1, wherein an electrolyte injection port is further formed in the side surface of the lower case adjacent to the connection part.

8. The case for a secondary battery as claimed in claim 1, wherein at least one of the upper case and the lower case is formed from Stainless Use Steel.

9. A secondary battery, the secondary battery comprising:
an electrode assembly comprising a first electrode, a second electrode, and a separator interposed between the first electrode and the second electrode;
a lower case comprising a lower receiving space accommodating a first portion of the electrode assembly and a lower opening;
an upper case comprising an upper receiving space accommodating a second portion of the electrode assembly and an upper opening; and
a connection part integrally connecting a portion of the lower case and a portion of the upper case,
wherein the lower case and the upper case are folded about the connection part and are connected such that the lower opening and the upper opening face each other, and
wherein a through-hole is formed in a side surface of the lower case adjacent to the connection part, with an electrode terminal electrically connected to the electrode assembly being disposed in the through-hole.

10. The secondary battery as claimed in claim 9, wherein the lower case comprises a bottom part, and a lower sidewall part extending from the bottom part toward the lower opening, and the upper case comprises a top part and an upper sidewall part extending from the top part toward the upper opening.

11. The secondary battery as claimed in claim 10, wherein a height of the lower sidewall part of the lower case is greater than a height of the upper sidewall part of the upper case.

12. The secondary battery as claimed in claim 10, wherein the through-hole is formed in a region the lower sidewall part such that an electrical short circuit between the upper case and the electrode terminal cannot occur.

13. The secondary battery as claimed in claim 10, wherein the upper case further comprises an upper flange part extending outward from an end of the upper sidewall part excluding a portion of the upper sidewall part corresponding to the connection part, and the lower case further comprises a lower flange part extending outward from an end of the lower sidewall part excluding a portion of the lower sidewall part corresponding to the connection part.

14. The secondary battery as claimed in claim 13, wherein the upper flange part and the lower flange part are connected by welding.

15. The secondary battery as claimed in claim 9, wherein at least one of the upper case and the lower case is electrically connected to the second electrode.

16. The secondary battery as claimed in claim 9, wherein an electrolyte injection port is further formed on the side surface of the lower case adjacent to the connection part.

17. A method of manufacturing a secondary battery, the method comprising:
preparing an electrode assembly comprising a first electrode, a second electrode, and a separator interposed between the first electrode and the second electrode;
preparing a lower case comprising a lower receiving space for accommodating a first portion of the electrode assembly and a lower opening, and an upper case comprising an upper receiving space for accommodating a second portion of the electrode assembly and an upper opening, wherein a portion of the upper case and a portion of the lower case are integrally connected by a connection part;
inserting the electrode assembly into the lower receiving space of the lower case; and
connecting the upper case and the lower case by folding the lower case and the upper case about the connection part such that the lower opening and the upper opening face each other.

18. The method of manufacturing a secondary battery as claimed in claim 17, wherein the lower case comprises a bottom part and a lower sidewall part extending from the bottom part toward the lower opening, and the upper case comprises a top part and an upper sidewall part extending from the top part toward the upper opening.

19. The method of manufacturing a secondary battery as claimed in claim 18, wherein a height of the lower sidewall part of the lower case is greater than a height of the upper sidewall part of the upper case.

20. The method of manufacturing a secondary battery as claimed in claim 18, wherein preparing the lower case and the upper case comprises forming a through-hole in a region of the lower sidewall part,
wherein the method further comprises disposing the electrode terminal in the through-hole and electrically connecting the electrode terminal and the first electrode, and
wherein the region of the lower sidewall part is positioned such that an electrical short circuit between the upper case and the electrode terminal cannot occur.
